(19) United States
(12) Patent Application Publication
(10) Pub. No.: US 2016/0035137 A1
(43) Pub. Date: Feb. 4, 2016

(54) DISPLAY DEVICE, METHOD OF CONTROLLING DISPLAY DEVICE, AND PROGRAM

(71) Applicant: SEIKO EPSON CORPORATION, Tokyo (JP)

(72) Inventors: Kaori SENDAI, Okaya-shi (JP); Atsunari TSUDA, Suwa-shi (JP); Masahide TAKANO, Matsumoto-shi (JP)

(21) Appl. No.: 14/720,115

(22) Filed: May 22, 2015

(30) Foreign Application Priority Data
Jul. 31, 2014 (JP) 2014-156647

(51) Int. Cl. G06T 19/00; G06T 7/00; G02B 27/01

(52) U.S. Cl. CPC G06T 19/006; G02B 27/017; G06T 7/0042

(57) ABSTRACT

A head mounted display device includes an image display unit which is used by being mounted on a body of a user, through which outside scenery is transmitted, and which displays an image such that the image is visually recognizable together with the outside scenery. The head mounted display device includes a target detection unit that detects a target of the user in a visual line direction and a data acquisition unit that acquires data of the image displayed by the image display unit. The head mounted display device includes an image display control unit that allows the image to be displayed in a position in which the image is visually recognized by overlapping at least a part of the target detected by the target detection unit based on the data acquired by the data acquisition unit.

### BACKGROUND

1. Technical Field

The present invention relates to a display device, a method of controlling a display device, and a program.

2. Related Art

In the related art, in a wearable display device, a device which performs display by overlapping the outside view is known (for example, see JP-A-2014-56217). The device disclosed in JP-A-2014-56217 has a configuration of displaying an image by overlapping characters with the outside view and makes some characters in sentences be easily recognized by changing display attributes, such as the font size or the color of characters, of some characters or words to be displayed.

JP-A-2014-56217 discloses a display method in a case where a user using a wearable display device sees one of characters or the outside view displayed by a display device. However, a display method made by considering a case in which the user visually recognizes characters together with the outside view has not been suggested in the related art.

### SUMMARY

An advantage of some aspects of the invention is to provide a display device capable of effectively combining the outside view seen by a user and display contents; a method of controlling a display device, and a program.

An aspect of the invention is directed to a display device which is used by being mounted on a body of a user, the display device including: a display unit through which outside scenery is transmitted and that displays an image such that the image is visually recognizable together with the outside scenery; a target detection unit that detects a target of the user in a visual line direction; a data acquisition unit that acquires data of the image displayed by the display unit; and an image display control unit that allows the image to be displayed based on the data acquired by the data acquisition unit such that the image overlaps at least a part of the target detected by the target detection unit.

According to the aspect of the invention, it is possible to change the appearance of the target present outside of the display device using an image being displayed by the display device by displaying the image so as to overlap the target seen as the outside scenery. Accordingly, it is possible to provide a new utilization method of displaying an image using a display device by effectively combining the outside scenery present outside of the display device and the display contents.

In the display device, the target detection unit may detect the target having a predetermined attribute and the image display control unit may allow the display unit to display the image having an attribute corresponding to the attribute of the target detected by the target detection unit.

According to the aspect of the invention with this configuration, the image corresponding to the attribute of the target seen as the outside scenery is displayed such that the image is seen by the user in a state of being overlapped with the target. Accordingly, it is possible to change the appearance of the target using the image displayed by the display device in correspondence with the attribute of the target.

The display device may further include a memory unit that stores features of the target detected by the target detection unit and feature data in correspondence with the attribute of the target and the target detection unit may detect the target corresponding to the feature data and may determine the attribute of the detected target.

According to the aspect of the invention with this configuration, it is possible to rapidly detect the target of the user in the visual line direction and determine the attribute of the detected target.

In the display device, the image display control unit may generate the image having an attribute corresponding to the attribute of the target detected by the target detection unit or acquire the image corresponding to the attribute of the target from the image included in the data acquired by the data acquisition unit.

According to the aspect of the invention with this configuration, it is possible to suitably display an image corresponding to the attribute of the target.

The display device may further include an imaging unit that images the visual line direction of the user and the target detection unit may detect the target which is visually recognized by the user through the display unit by detecting an image corresponding to a feature of the target from the captured image of the imaging unit.

According to the aspect of the invention with this configuration, it is possible to easily detect the target in the visual line direction of the user based on the captured image.

The display device may further include a position detection unit that detects a position of the target with respect to a display region of the display unit and the image display control unit may determine a display position of an image based on the position of the target detected by the position detection unit and allow the display unit to display the image.

According to the aspect of the invention with this configuration, it is possible to display an image according to the position of the target.

In the display device, the position detection unit may detect a position in which the user visually recognizes the target through the display region of the display unit.

According to the aspect of the invention with this configuration, since the position that displays an image can be suitably determined, it is possible to display an image so as to overlap the target which is seen through the display region.

Another aspect of the invention is directed to a method of controlling a display device which includes a display unit through which outside scenery is transmitted and that displays an image such that the image is visually recognizable together with the outside scenery and which is used by being mounted on a body of a user, the method including: detecting a target of the user in a visual line direction; acquiring data of the image displayed by the display unit; and allowing the image to be displayed based on the acquired data such that the image overlaps at least a part of the target.

According to the aspect of the invention, it is possible to change the appearance of the target present outside of the display device using an image being displayed by the display device by displaying the image so as to overlap the target seen as the outside scenery. Accordingly, it is possible to provide a new utilization method of displaying an image using a display device by effectively combining the outside scenery present outside of the display device and the display contents.

Still another aspect of the invention is directed to a program which can be executed by a computer controlling a display device that includes a display unit through which outside scenery is transmitted and that displays an image such that the image is visually recognizable together with the outside scenery and is used by being mounted on a body of a user, the program causing the computer to function as: a target detection unit that detects a target of the user in a visual line direction; a data acquisition unit that acquires data of the image displayed by the display unit; and an image display control unit that allows the image to be displayed based on the data acquired by the data acquisition unit such that the image overlaps at least a part of the target detected by the target detection unit.

According to the aspect of the invention, it is possible to change the appearance of the target present outside of the display device using an image being displayed by the display device by displaying the image so as to overlap the target seen as the outside scenery. Accordingly, it is possible to provide a new utilization method of displaying an image using a display device by effectively combining the outside scenery present outside of the display device and the display contents.

### BRIEF DESCRIPTION OF THE DRAWINGS

The invention will be described with reference to the accompanying drawings, wherein like numbers reference like elements.

FIG. 1 is a view illustrating an external configuration of a head mounted display device.

FIG. 2 is a block diagram illustrating a functional configuration of the head mounted display device.

FIG. 3 is a view illustrating an example of data to be stored in a memory unit.

FIG. 4 is a flowchart illustrating an operation of the head mounted display device.

FIG. 5 is a flowchart specifically illustrating a target detecting process.

FIG. 6 is a flowchart specifically illustrating a displaying process.

FIGS. 7A to 7D are views illustrating typical application examples of the head mounted display device. FIG. 7A illustrates an example of the field of vision of a user, FIG. 7B illustrates an example of a captured image, FIG. 7C illustrate an example in which an image is overlapped with the field of vision, and FIG. 7D illustrates an example of the field of vision of the user in the case where the image is overlapped with the field of vision.

### DESCRIPTION OF EXEMPLARY EMBODIMENTS

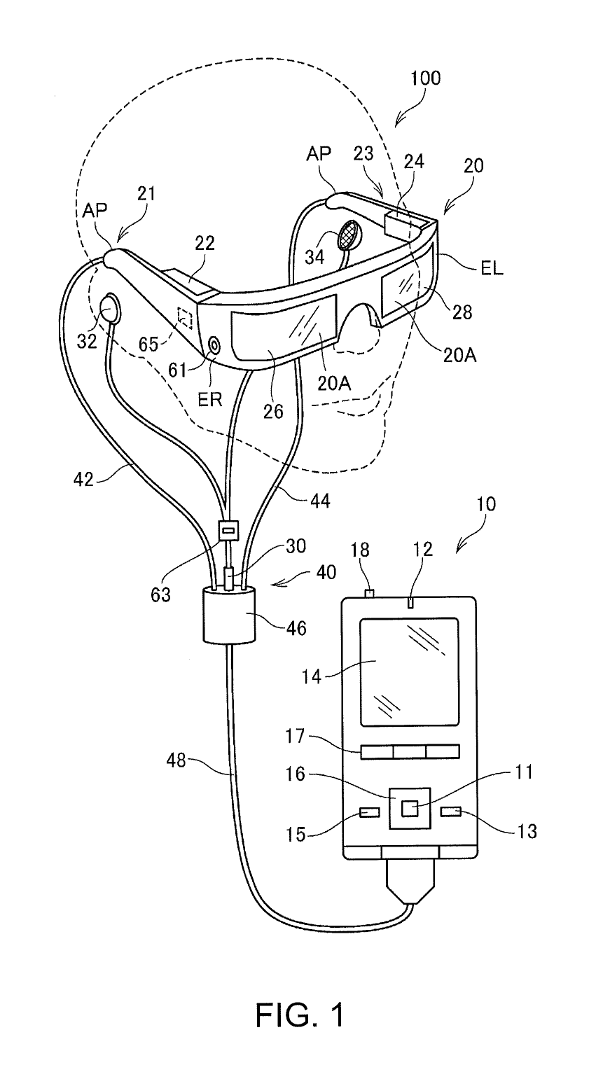

FIG. 1 is an explanatory view illustrating an external configuration of a head mounted display device 100. The head mounted display device 100 is a display device that is mounted on a head and referred to as a head mounted display (HMD). The head mounted display device 100 according to the present invention is an optical transmission type head mounted display device in which the outside scenery can be directly visually recognized at the same time as when a virtual image is visually recognized by a user. Further, in the present specification, the virtual image visually recognized by the user using the head mounted display device 100 is conveniently referred to as a “display image.” Further, emitting image light generated based on image data is expressed as “displaying an image.”

The head mounted display device 100 includes an image display unit 20 that allows the user to visually recognize a virtual image in a state in which the head mounted display device is mounted on the head of the user and a control device 10 that controls the image display unit 20. The control device 10 functions as a controller used for the user to operate the head mounted display device 100. The image display unit 20 is also simply referred to as a “display unit.”

The image display unit 20 is a mounted body to be mounted on the head of the user and has a shape of glasses in the present embodiment. The image display unit 20 includes a right holding unit 21, a right display driving unit 22, a left holding unit 23, a left display driving unit 24, a right optical image display unit 26, a left optical image display unit 28, a camera 61 (imaging unit), and a microphone 63. The right optical image display unit 26 and the left optical image display unit 28 are respectively arranged so as to be positioned in front of right and left eyes of the user when the image display unit 20 is mounted on the head of the user. One end of the right optical image display unit 26 and one end of the left optical image display unit 28 are connected to each other in a position corresponding to a place between eyebrows of the user when the image display unit 20 is mounted on the head of the user.

The right holding unit 21 is a member provided in a state of being extended from an end portion ER which is the other end of the right optical image display unit 26 to a position corresponding to a side head portion of the user when the image display unit 20 is mounted on the head of the user. Similarly, the left holding unit 23 is a member provided in a state of being extended from an end portion EL which is the other end of the left optical image display unit 28 to a position corresponding to a side head portion of the user when the image display unit 20 is mounted on the head of the user. The right holding unit 21 and the left holding unit 23 hold the image display unit 20 on the head portion of the user in a shape of temples (bows) of glasses.

The right display driving unit 22 and the left display driving unit 24 are arranged on the side facing the head portion of the user when the image display unit 20 is mounted on the user. Hereinafter, the right holding unit 21 and the left holding unit 23 are simply and collectively referred to as “holding units,” the right display driving unit and the left display driving unit 24 are simply and collectively referred to as “display driving units,” and the right optical image display unit 26 and the left optical image display unit 28 are simply and collectively referred to as “optical image display units.”

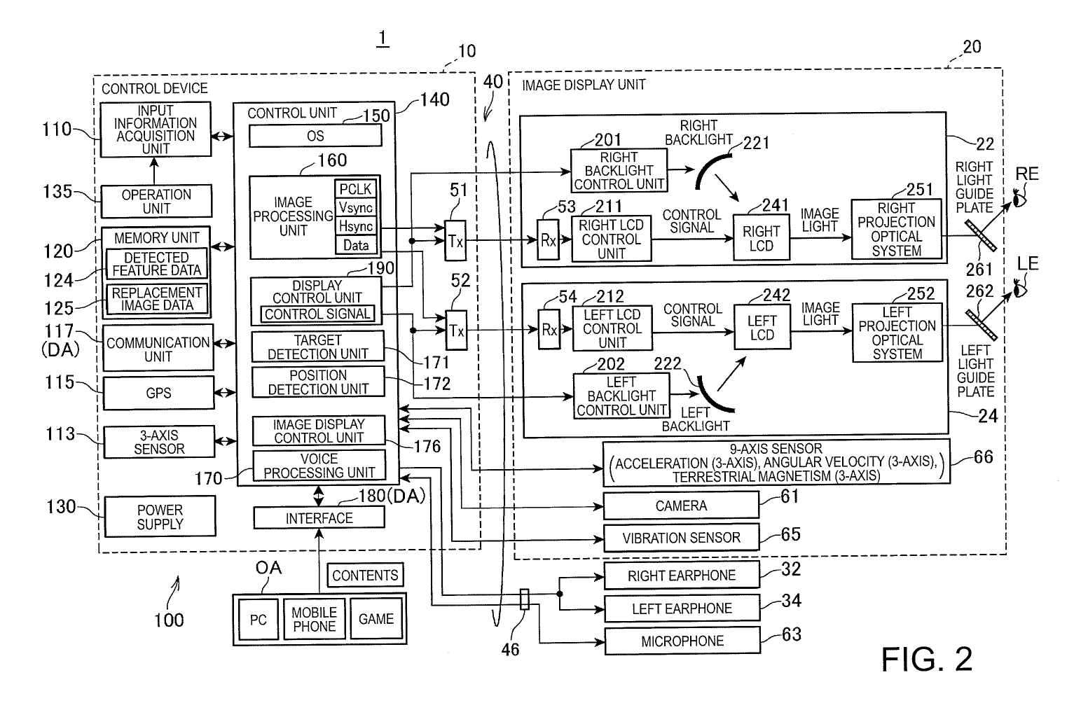

The display driving units 22 and 24 include liquid crystal displays 241 and 242 (hereinafter, also referred to as “LCDs 241 and 242”) or projection optical systems 251 and 252 (see FIG. 2). The details of the configurations of the display driving units 22 and 24 will be described below. The optical image display units 26 and 28 serving as optical members include light guide plates 261 and 262 (see FIG. 2) and a light adjusting plate 20A. The light guide plates 261 and 262 are formed of a resin with optical transparency or the like and guide image light output from the display driving units 22 and 24 to the eyes of the user. The light adjusting plate 20A is a thin plate-like optical element and is arranged so as to cover the front side of the image display unit 20 which is the opposite side of the eyes of the user. As the light adjusting plate 20A, various plates such as a plate with substantially no optical transparency, a nearly transparent plate, a plate through which light is transmitted by attenuating the amount of light, and a plate that attenuates or reflects light with a specific wavelength can be used. By suitably selecting optical characteristics (optical transmittance and the like) of the light adjusting plate 20A, the amount of external light which is incident to the right optical image display unit 26 and the left optical image display unit 28 from the outside is adjusted and thus ease of visual recognition of a virtual image can be adjusted. In the present embodiment, a case in which the light adjusting plate 20A having optical transparency at least to the extent that the outside scenery can be visually recognized by the user on which the head mounted display device 100 is mounted is used is described. The light adjusting plate 20A protects the right light guide plate 261 and the left light guide plate 262 so that damage of the right light guide plate 261 and the left light guide plate 262 and adhesion of dirt thereto are suppressed.

The light adjusting plate 20A can be detachably attached to the right optical image display unit 26 and the left optical image display unit 28, plural kinds of light adjusting plates 20A are replaceable and can be mounted, or the light adjusting plate may be omitted.

The camera 61 is arranged in the end portion ER which is the other end of the right optical image display unit 26. The camera 61 images the outside scenery which is the outside view in a direction on the opposite side of the eyes of the user and acquires an image of the outside scenery. The camera 61 of the present embodiment illustrated in FIG. 1 is a single-lens camera, but may be a stereo camera.

An imaging direction, that is, the angle of view of the camera 61 is a front side direction of the head mounted display device 100, in other words, a direction in which at least a part of the outside scenery in the visual field direction of the user is imaged in a state of the head mounted display device 100 being mounted on the user. Further, the range of the angle of view of the camera 61 can be suitably set, but it is preferable that the imaging range of the camera 61 is a range including the outside world (outside scenery) that is visually recognized by the user through the right optical image display unit 26 and the left optical image display unit 28. Further, it is more preferable that the imaging range of the camera 61 is set such that the entire visual field of the user through the light adjusting plate 20A can be imaged.

The image display unit 20 further includes a connecting unit 40 that connects the image display unit 20 with the control device 10. The connecting unit 40 includes a main cord 48 connected to the control device 10, a right cord 42, a left cord 44, and a coupling member 46. The right cord 42 and the left cord 44 are cords in which the main cord 48 is branched into two cords. The right cord 42 is inserted into a housing of the right holding unit 21 from the tip portion AP of the right holding unit 21 in the extension direction and connected to the light display driving unit 22. Similarly, the left cord 44 is inserted into a housing of the left holding unit 23 from the tip portion AP of the left holding unit 23 in the extension direction and connected to the left display driving unit 24.

The coupling member 46 is provided in a branch point of the main cord 48, the right cord 42, and the left cord 44 and has a jack that connects an earphone plug 30. A right earphone 32 and a left earphone 34 are extended from the earphone plug 30. The microphone 63 is provided in the vicinity of the earphone plug 30. The cords are combined into one cord from the earphone plug 30 to the microphone 63, branched from the microphone 63, and respectively connected to the right earphone 32 and the left earphone 34.

The specific specification of the microphone 63 is optional. The microphone 63 may be a directional microphone or a nondirectional microphone. Examples of the directional microphone include a cardioid microphone, a supercardioid microphone, a hypercardioid microphone, and an ultracardioid microphone. In a case where the microphone 63 has directivity, the microphone may have a configuration in which the voice from the visual line direction of the user on which the head mounted display device 100 is mounted is particularly excellently collected and then detected. In this case, the microphone 63 or a component accommodating the microphone 63 may have structural characteristics in order to secure the directivity of the microphone 63. For example, in the example of FIG. 1, the microphone 63 and the coupling member 46 may be designed such that a sound collecting unit of the microphone 63 is directed to the visual line direction of the user in a state of the user on which the right earphone 32 and the left earphone 34 are mounted. Alternatively, the microphone 63 may be disposed by being embedded in the right holding unit 21 or the left holding unit 23. In this case, when a hole for collecting sound is formed on the front surface side of the right holding unit 21 or the left holding unit 23, that is, a surface which is located parallel to the right optical image display unit 26 and the left optical image display unit 28, the microphone can have directivity corresponding to the visual line direction of the user. The visual line direction of the user is, in other words, a direction in which the right optical image display unit 26 and the left optical image display unit 28 face, a direction toward the center of the visual field which is seen by the user over the right optical image display unit 26 and the left optical image display unit 28, or an imaging direction of the camera 61. In addition, the direction of the directivity of the microphone 63 may vary. In this case, the microphone may have a configuration in which the visual line direction of the user is detected and the visual line direction of the microphone 63 is adjusted so as to face the direction.

In addition, the right cord 42 and the left cord 44 can be combined into one cord. A conductive wire in the inside of the right cord 42 is drawn into the left holding unit 23 side through the inside of the main body of the image display unit 20 and coated with a resin together with a conductive wire in the inside of the left cord 44, and both cords may be combined into one cord.

The image display unit 20 and the control device 10 transmit various signals through the connecting unit 40. The end portion on the opposite side of the coupling member 46 in the main cord 48 and the control device 10 are respectively provided with connectors (not illustrated) engaged with each other. The control device 10 and the image display unit 20 are connected with each other or separated from each other due to engagement or disengagement of the connector of the main cord 48 and the connector of the control device 10. For example, metal cables or optical fibers can be applied to the right cord 42, the left cord 44, and the main cord 48.

The control device 10 is a device that controls the head mounted display device 100. The control device 10 includes switches having a determination key 11, a lighting unit 12, a display switching key 13, a brightness switching key 15, a direction key 16, a menu key 17, and a power supply switch 18. Further, the control device 10 includes a trackpad 14 that is manipulated by a touch operation of the user using a finger.

The determination key 11 outputs a signal that detects a pressing operation and determines the content operated by the control device 10. The lighting unit 12 notifies an operation state of the head mounted display device 100 according to the light emission state thereof. As the operation state of the head mounted display device 100, an On or Off state of the power supply can be exemplified. For example, a light emitting diode (LED) is used as the lighting unit 12. The display switching key 13 detects the pressing operation and outputs a signal that switches the display mode of a content video with 3D or 2D.

The trackpad 14 detects the operation of the user using a finger of the user on the operation surface of the trackpad 14 and outputs a signal according to the detected contents. As the trackpad 14, various trackpads such as an electrostatic trackpad, a pressure detecting trackpad, and an optical trackpad can be employed. The brightness switching key 15 detects a pressing operation and outputs a signal that increases or decreases the brightness of the image display unit 20. The operation key 16 detects the pressing operation on the key corresponding to the vertical direction and the horizontal direction and outputs a signal according to the detected contents. The power supply switch 18 switches the power supply state of the head mounted display device 100 by detecting a slide operation of the switch.

FIG. 2 is a functional block diagram of respective units constituting a display system 1 according to the present embodiment.

As illustrated in FIG. 2, the display system 1 includes an external device OA and the head mounted display device 100. Examples of the external device OA include a personal computer (PC), a mobile phone terminal, and a game terminal. The external device OA is used as an image supply device that supplies an image to the head mounted display device 100.

The control device 10 of the head mounted display device 100 includes a control unit 140, an operation unit 135, an input information acquisition unit 110, a memory unit 120, a power supply 130, an interface 180, a transmission unit (Tx) 51, and a transmission unit (Tx) 52.

The operation unit 135 detects the operation of the user. The operation unit 135 includes respective units such as the determination key 11, the display switching key 13, the trackpad 14, the brightness switching key 15, the direction key 16, the menu key 17, and the power supply switch 18 illustrated in FIG. 1.

The input information acquisition unit 110 acquires a signal according to an operation input performed by the user. As the signal according to the operation input, an operation input with respect to the trackpad 14, the direction key 16, or the power supply switch 18 can be exemplified.

The power supply 130 supplies power to respective units of the head mounted display device 100. As the power supply 130, for example, a secondary battery can be used.

The memory unit 120 stores various computer programs. The memory unit 120 is configured of a ROM or a RAM. The memory unit 120 may store image data displayed on the image display unit 20 of the head mounted display device 100.

The memory unit 120 stores detected feature data 124 referenced by the target detection unit 171 described below and replacement image data 125 processed by the image display control unit 176.

The interface 180 is an interface for connecting various external devices OA serving as sources of supplying content to the control device 10. As the interface 180, for example, an interface corresponding to the wired connection such as a USB interface, a micro USB interface, and an interface for a memory card can be used.

The control unit 140 realizes the functions of respective units by reading and executing the computer programs stored in the memory unit 120. That is, the control unit 140 functions as an operating system (OS) 150, an image processing unit 160, a voice processing unit 170, a target detection unit 171, a position detection unit 172, an image display control unit 176, and a display control unit 190.

A 3-axis sensor 113, a GPS 115, and a communication unit 117 are connected to the control unit 140. The 3-axis sensor 113 is a 3-axis acceleration sensor and a detection value of the 3-axis sensor 113 can be acquired by the control unit 140. The GPS 115 includes an antenna (not illustrated), receives a global positioning system (GPS) signal, and acquires the current position of the control device 10. The GPS 115 outputs the current position or the current time acquired based on the GPS signal to the control unit 140. Further, the GPS 115 acquires the current time based on information included in the GPS signal and may have a function of correcting the time clocked by the control unit 140 of the control device 10.

The communication unit 117 performs wireless data communication in conformity with standards such as a wireless LAN (WiFi (registered trademark)), Miracast (registered trademark), and Bluetooth (registered trademark).

In a case where the external device OA is connected to the communication unit 117 in a wireless manner, the control unit 140 acquires content data from the communication unit 117 and performs control for displaying an image on the image display unit 20. Meanwhile, in a case where the external device OA is connected to the interface 180 in a wired manner, the control unit 140 acquires content data from the interface 180 and performs control for displaying an image on the image display unit 20. Accordingly, hereinafter, the communication unit 117 and the interface 180 are collectively referred to as data acquisition units DA.

The data acquisition units DA acquire the content data to be displayed by the head mounted display device 100 from the external device OA. The content data includes image data described below.

The image processing unit 160 acquires an image signal included in the contents. The image processing unit 160 separates a synchronization signal such as a vertical synchronization signal VSync or a horizontal synchronization signal HSync from the acquired image signal. Further, the image processing unit 160 generates a clock signal PCLK using a phase locked loop (PLL) circuit (not illustrated) or the like according to the synchronization of the separated vertical synchronization signal VSync or horizontal synchronization signal HSync. The image processing unit 160 converts an analog image signal from which a synchronization signal is separated to a digital image signal using an A/D conversion circuit (not illustrated) or the like. Next, the image processing unit 160 stores the converted digital image signal in a DRAM of the memory unit 120 for each frame as image data (in the figure, Data) of the target image. The image data is, for example, RGB data.

In addition, the image processing unit 160 may perform image processing, for example, various color tone correction processing such as resolution conversion processing and adjusting the brightness or saturation, and keystone correction processing with respect to the image data as needed.

The image processing unit 160 transmits each of the generated clock signal PCLK, the vertical synchronization signal VSync, the horizontal synchronization signal HSync, and image data Data stored in the DRAM of the memory unit 120 through the transmission units 51 and 52. The image data Data transmitted through the transmission unit 51 is referred to as “image data for the right eye” and the image data Data transmitted through the transmission unit 52 is referred to as “image data for the left eye.” The transmission units 51 and 52 function as a transceiver for serial transmission between the control device 10 and the image display unit 20.

The display control unit 190 generates a control signal that controls the right display driving unit 22 and the left display driving unit 24. Specifically, the display control unit 190 individually controls, with the control signal, ON/OFF driving of a right LCD 241 using a right LCD control unit 211; ON/OFF driving of a right backlight 221 using a right backlight control unit 201; ON/OFF driving of a left LCD 242 using a left LCD control unit 212; and ON/OFF driving of a left backlight 222 using a left backlight control unit 202. In this manner, the display control unit 190 controls generation and emission of image light using each of the right display driving unit 22 and the left display driving unit 24. For example, the display control unit 190 allows both of the right display driving unit 22 and the left display driving unit 24 to generate image light, allows only one of the right display driving unit 22 and the left display driving unit 24 to generate image light, or allows both not to generate image light.

The display control unit 190 respectively transmits the control signals to the right LCD control unit 211 and the left LCD control unit 212 through the transmission units 51 and 52. In addition, the display control unit 190 respectively transmits the control signals to the right backlight control unit 201 and the left backlight control unit 202.

The image display unit 20 includes the right display driving unit 22, the left display driving unit 24, the right light guide plate 261 serving as the right optical image display unit 26, the left light guide plate 262 serving as the left optical image display unit 28, the camera 61, a vibration sensor 65, and a 9-axis sensor 66.

The vibration sensor 65 is configured using an acceleration sensor and is arranged in the inside of the image display unit 20 as illustrated in FIG. 1. In the right holding unit 21 of the example of FIG. 1, the vibration sensor 65 is incorporated in the vicinity of the end portion ER of the right optical image display unit 26. In a case where the user performs an operation of knocking the end portion ER, the vibration sensor 65 detects the vibration caused by the operation and outputs the detected results to the control unit 140. The control unit 140 detects the knocking operation of the user using the detected results of the vibration sensor 65.

The 9-axis sensor 66 is a motion sensor that detects the acceleration (3-axis), the angular velocity (3-axis), and the terrestrial magnetism (3-axis). Since the 9-axis sensor 66 is provided in the image display unit 20, the 9-axis sensor detects the motion of the head of the user when the image display unit 20 is mounted on the head of the user. Since the orientation of the image display unit 20 can be seen from the detected motion of the head of the user, the control unit 140 can assume the visual line direction of the user.

The right display driving unit 22 includes a receiving unit (Rx) 53; a right backlight (BL) control unit 201 and a right backlight (BL) 221 functioning as light sources; a right LCD control unit 211 and a right LCD 241 functioning as display elements; and a right projection optical system 251. The right backlight control unit 201 and the right backlight 221 function as light sources. The right LCD control unit 211 and the right LCD 241 function as display elements. In addition, the right backlight control unit 201, the right LCD control unit 211, the right backlight 221, and the right LCD 241 are also collectively referred to as “image light generation units.”

The receiving unit 53 functions as a receiver for serial transmission between the control device 10 and the image display unit 20. The right backlight control unit 201 drives the right backlight 221 based on the input control signal. The right backlight 221 is a light emitting body such as an LED or electroluminescence (EL). The right LCD control unit 211 drives the right LCD 241 based on the clock signal PCLK input through the receiving unit 53, the vertical synchronization signal VSync, the horizontal synchronization signal HSync, and image data Data 1 for a right eye. The right LCD 241 is a transmissive liquid crystal panel in which a plurality of pixels are arranged in a matrix.

The right projection optical system 251 is configured of a collimating lens that makes image light emitted from the right LCD 241 into a parallel light flux. The right light guide plate 261 serving as the right optical image display unit 26 guides the image light output from the right projection optical system 251 to a right eye RE of the user while reflecting the image light along a predetermined optical path. Further, the right projection optical system 251 and the right light guide plate 261 are also collectively referred to as “light guide units.”

The left display driving unit 24 has a configuration which is the same as that of the right display driving unit 22. The left display driving unit 24 includes a receiving unit (Rx) 54; a left backlight (BL) control unit 202 and a left backlight (BL) 222 functioning as light sources; a left LCD control unit 212 and a left LCD 242 functioning as display elements; and a left projection optical system 252. The left backlight control unit 202 and the left backlight 222 function as light sources. The left LCD control unit 212 and the left LCD 242 function as display elements. In addition, the left backlight control unit 202, the left LCD control unit 212, the left backlight 222, and the left LCD 242 are also collectively referred to as “image light generation units.” The left projection optical system 252 is configured of a collimating lens that makes image light emitted from the left LCD 242 into a parallel light flux. The left light guide plate 262 serving as the left optical image display unit 28 guides the image light output from the left projection optical system 252 to a left eye LE of the user while reflecting the image light along a predetermined optical path. Further, the left projection optical system 252 and the left light guide plate 262 are also collectively referred to as “light guide units.”

The head mounted display device 100 displays an image based on the image data so as to overlap the outside scenery in a case where the user sees the outside scenery through the right optical image display unit 26 and the left optical image display unit 28.

The target detection unit 171 performs control of allowing the camera 61 to image the target and acquires the captured image. The captured image is output from the camera 61 as colored image data or monochrome image data, but the camera 61 outputs the image signal and the target detection unit 171 may generate the image data conforming to a predetermined file format from the image signal.

The target detection unit 171 analyzes the acquired captured image data and detects the target reflected on the captured image data. The target is an object or a person present in the imaging direction of the camera 61, that is, the visual line direction of the user.

The target detection unit 171 searches an image matching the detected feature data 124 in the captured image and detects the image matching the detected feature data as an image of a target.

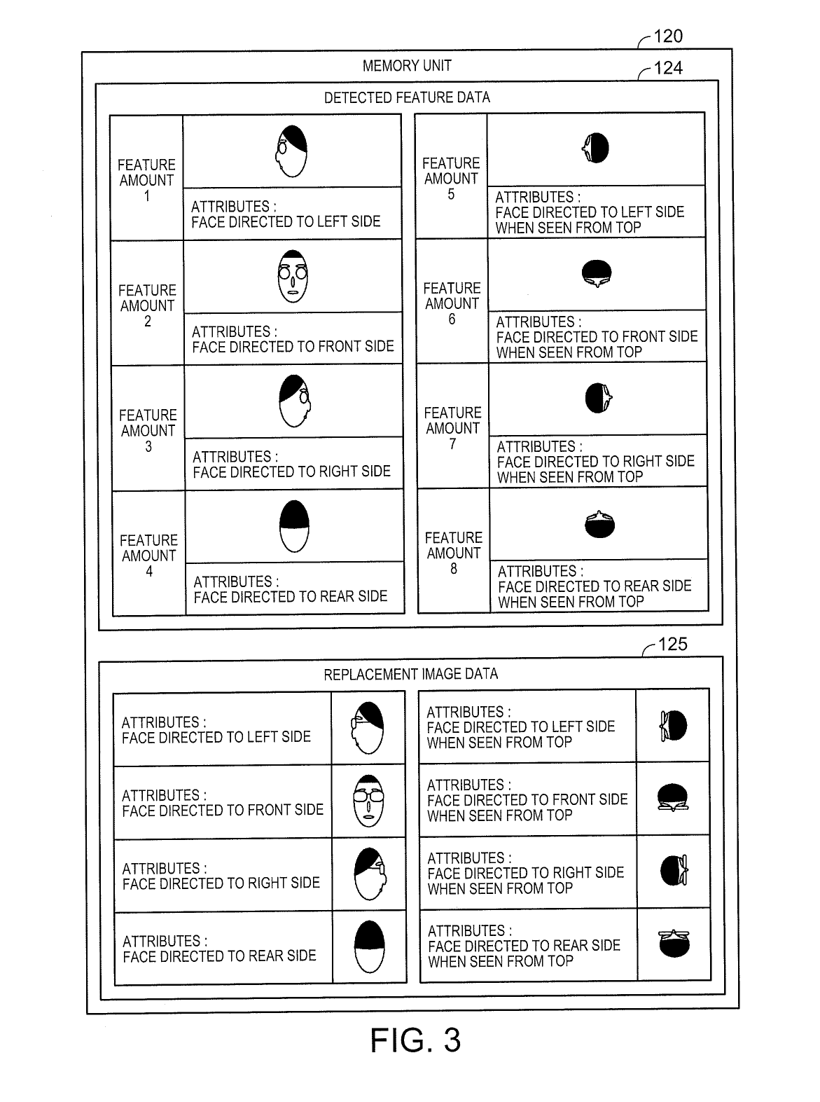

FIG. 3 is a view illustrating a configuration example of the detected feature data 124 and the replacement image data 125 stored in the memory unit 120.

The detected feature data 124 is data of the feature amount of the image detected from the captured image. In the example of FIG. 3, the detected feature data 124 includes eight types of feature amounts of feature amounts 1 to 8. Each feature amount corresponds to an image to be detected. Each feature amount corresponds to an attribute. For example, the feature amount 1 is a feature amount for detecting an image of a person's face directed to the left side from the captured image and corresponds to “a face directed to the left side” as the attribute. Further, for example, the feature amount 2 is a feature amount for detecting an image of a person's face directed to the front side from the captured image and corresponds to “a face directed to the front side” as the attribute. The same applies to other feature amounts 3 to 8. In the example of FIG. 3, it is possible to detect eight types of images of a person's face directed to different directions using the feature amounts 1 to 8. In addition, the detected feature data 124 includes parameters and mathematical formulae in which the shape, the size, or the color of an image to be detected is digitized. The detected feature data 124 does not necessarily include image data as an image itself as illustrated in FIG. 3. Further, the detected feature data 124 in the example of FIG. 3 includes eight types of feature amounts. However, the number of feature amounts is not particularly limited and the detected feature data 124 may include one feature amount.

The target detection unit 171 obtains attributes of a feature amount matching a detected image in a case where an image of a target is detected based on the detected feature data 124 from a captured image.

The detected feature data 124 may be (1) a feature amount of an image of a face of a specific person or a character modeled on the shape of a person or (2) a feature amount of an image for detecting a normal person's face or an image similar to a person's face. In the case of (1), the target detection unit 171 detects a face of a specific person or a character modeled on the shape of a person from a captured image, but a face of another person or another character is not detected. In the case of (2), the target detection unit 171 detects an image of a person's face or an image similar to a person's face, but a shape which is not similar to a person's face or a colored object is not detected.

The position detection unit 172 detects the position of the target detected by the target detection unit 171 with respect to the display region in which an image is displayed by the image display unit 20. The image displayed by the right optical image display unit 26 and the left optical image display unit 28 is visually recognized by both eyes of the user and the image is overlapped with external light transmitted through the light adjusting plate 20A. Accordingly, the user visually recognizes the outside scenery in an overlapped manner with the image displayed by the right optical image display unit 26 and the left optical image display unit 28. Here, the range in which an image displayed by the right optical image display unit 26 and the left optical image display unit 28 is seen by the user is set as a display region of the image display unit 20. The display region is the maximum range in which the image displayed by the image display unit 20 can be visually recognized and the image display unit 20 displays an image in the whole or a part of the display region.

The position detection unit 172 acquires the relative position between the position in which the target is seen by the user and the position in which the image displayed by the image display unit 20 is seen based on the position of the image of the target in the captured image of the camera 61. In this process, information showing a positional relationship between the display region of the image display unit 20 and the imaging range (angle of view) of the camera 61 is required. In place of the information, information showing a positional relationship between the visual field (field of vision) of the user and the imaging range (angle of view) of the camera 61 and information showing a positional relationship between the visual field (field of vision) of the user and the display region of the image display unit 20 may be used. The information is stored in the memory unit 120 in advance.

Further, the position detection unit 172 may detect the position of the target and the size of the target with respect to the display region. In this manner, in a case where the image displayed by the image display unit 20 and the target in the outside scenery are seen by the user, the image can be displayed such that the size of the displayed image and the target image perceived by the user becomes a predetermined state.

The image display control unit 176 allows the image display unit 20 to display an image based on the results of processes performed by the target detection unit 171 and the position detection unit 172. The head mounted display device 100 may acquire various kinds of data such as moving images, still images, characters, and symbols using the data acquisition unit DA and the data can be used as display data. In the present embodiment, the control unit 140 allows the image data stored as the replacement image data 125 in the memory unit 120 from among the data acquired by the data acquisition unit DA to be displayed.

An example of the replacement image data 125 is illustrated in FIG. 3. The replacement image data 125 includes a piece of or a plurality of pieces of image data in correspondence with the attributes. Preferably, the image data included in the replacement image data 125 corresponds to the attribute of the feature amount included in the detected feature data 124. In the example of FIG. 3, since the detected feature data 124 includes eight types of feature amounts with attributes different from one another, the replacement image data 125 includes eight pieces of image data corresponding to the attributes of respective feature amounts.

The image display control unit 176 extracts image data corresponding to the attribute of the target detected by the target detection unit 171 from the replacement image data 125 and allows the image data to be displayed in a position detected by the position detection unit 172 using the display control unit 190. The head mounted display device 100 displays image data such that the user visually recognizes the image data together with the outside scenery using the function of the image display control unit 176.

As the attributes of the target, as described above, (1) a face of a specific person or a character modeled on the shape of a person or (2) a normal person's face or an image similar to a person's face can be exemplified. Further, in a case where the target is a face, the direction of the face seen by the user may be included in the attributes. In addition, the attributes are not particularly limited to a person's face, various kinds of objects such as a motorcycle, a four-wheeled vehicle, a bicycle, an airplane, a train, and a traffic signal can be included in the attributes. Alternatively, a fact that whether a target needs special attention or not may be included in the attributes. For example, a traffic signal, a breaker of a railroad crossing, a tollgate of a toll road, or a pedestrian crossing is set as a target that needs special attention and the target may be distinguished from other objects or people. In addition, in a case where the target is a person, the age, the gender, the physique, or the color of clothes may be included in the attributes. In addition, the attributes of the target can be suitably set according to a reference in which a user distinguishes the target seen by the user from other objects.

The feature amounts used by the target detection unit 171 which are included in the attributes may be stored in the memory unit 120 for each attribute. For example, the feature amounts corresponding to various attributes are stored in the memory unit 120 and the feature amounts and attributes used for determination can be selected by the operation of the control device 10.

The voice processing unit 170 acquires a voice signal included in the contents, amplifies the acquired voice signal, and supplies the voice signal to a speaker (not illustrated) in the right earphone 32 and a speaker (not illustrated) in the left earphone 34 connected to the coupling member 46. Further, in a case where a Dolby (registered trademark) system is employed, processing with respect to the voice signal is performed and different sounds whose frequencies or the like are changed are output from each of the right earphone 32 and the left earphone 34.

Further, the voice processing unit 170 performs processing related to a voice by acquiring the voice collected by the microphone 63 and converting the voice to digital voice data. For example, the voice processing unit 170 recognizes individual voices of a plurality of people and may perform speaker recognition that identifies a person who is speaking for each voice by extracting characteristics from the acquired voices and modeling the voices.

The 3-axis sensor 113, the GPS 115, and the communication unit 117 are connected to the control unit 140. The 3-axis sensor 113 is the 3-axis acceleration sensor and the control unit 140 can detect the motion of the control device 10 and the direction of the motion by acquiring the detection value of the 3-axis sensor 113.

The GPS 115 includes an antenna (not illustrated), receives a global positioning system (GPS) signal, and acquires the current position of the control device 10. The GPS 115 outputs the current position or the current time acquired based on the GPS signal to the control unit 140. Further, the GPS 115 acquires the current time based on information included in the GPS signal and may have a function of correcting the time clocked by the control unit 140 of the control device 10.

The communication unit 117 performs wireless data communication in conformity with standards such as a wireless LAN (WiFi (registered trademark)) and Bluetooth (registered trademark).

The interface 180 is an interface for connecting various image supply devices OA serving as sources of supplying contents to the control device 10. The contents supplied by the image supply device OA include moving images or still images and may include voices. As the image supply device OA, a personal computer (PC), a mobile phone terminal, or a game terminal can be exemplified. As the interface 180, for example, a USB interface, a micro USB interface, an interface for a memory card or the like can be used.

Here, the image supply device OA can be connected to the control device 10 using a wireless communication line. In this case, the image supply device OA performs wireless communication with the communication unit 117 and transmits content data using a wireless communication technique such as Miracast (registered trademark).

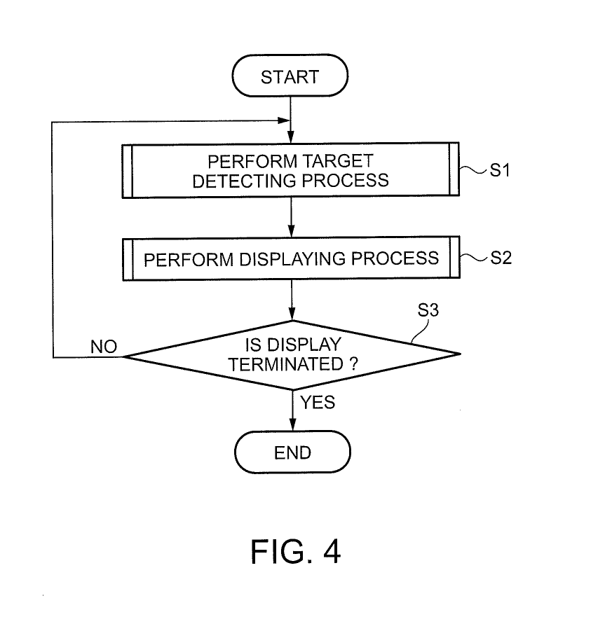

FIG. 4 is a flowchart illustrating the operation of the head mounted display device 100 and particularly illustrating a data displaying process using a function of the image display control unit 176. The data displaying process is a process in which the image data corresponding to the outside scenery is displayed by the image display unit 20 when the user sees the outside scenery through the right optical image display unit 26 and the left optical image display unit 28.

In the control unit 140 of the head mounted display device 100, the target detection unit 171 performs a target detecting process (Step S1). In Step S1, the target detection unit 171 detects an image of a target from the captured image of the camera 61 and the position detection unit 172 detects the position of the target. Next, the image display control unit 176 performs a displaying process, controls the display control unit 190 based on the results of processes performed by the target detection unit 171 and the position detection unit 172, and allows the image display unit 20 to display the image based on the image data (Step S2).

Respective processes of Steps S1 and S2 will be specifically described below.

Next, the control unit 140 determines whether to terminate the display (Step S3). In a case where the display is continued (Step S3: NO), the control unit 140 returns to Step S1. In addition, in a case where the display is terminated according to an operation or the like detected by the operation unit 135 (Step S3: YES), the control unit 140 terminates the main process by stopping the display of the display control unit 190.

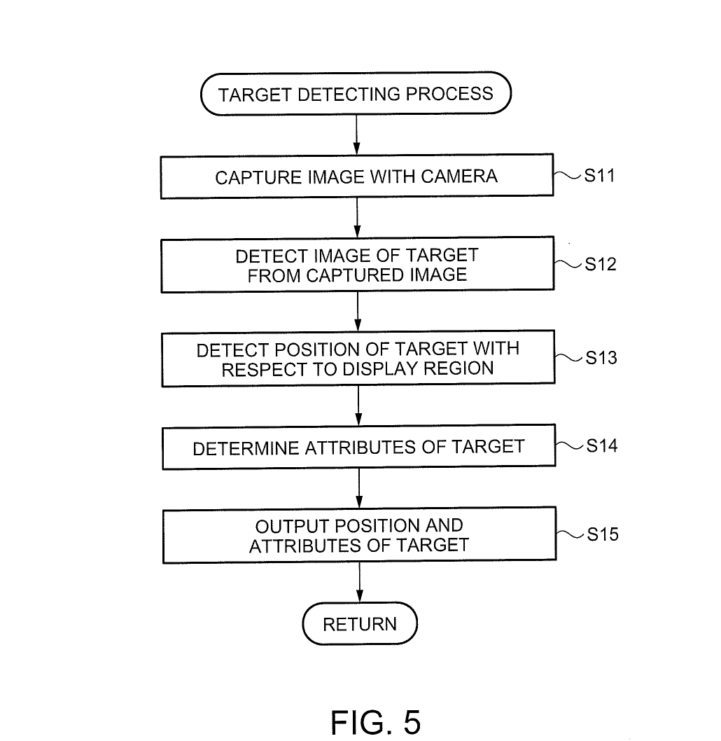

FIG. 5 is a flowchart specifically illustrating the target detecting process in Step S1 of FIG. 4.

The target detection unit 171 acquires the captured image by capturing an image with the camera 61 (Step S11) and detects an image of the target from the captured image (Step S12). Here, the target detection unit 171 acquires the detected feature data 124 from the memory unit 120, performs matching with respect to the captured image data using the feature amount of the detected feature data 124 as reference data, and detects an image matching the feature amount. Further, in a case where a plurality of images are detected, the target detection unit 171 may select one target closer to the visual line direction of the user. For example, an image of a target close to the center of the captured image of the camera 61 may be selected.

Next, the position detection unit 172 detects the position with respect to the display region in regard to the image of the target detected by the target detection unit 171 (Step S13). In Step S13, the position detection unit 172 suitably acquires information or the like showing the positional relationship between the display region and the angle of view of the camera 61 from the memory unit 120 as described above.

Further, the target detection unit 171 determines the attributes of the image of the target detected in Step S12 (Step S14). The attributes determined here are attributes determined by the target detection unit 171 as described above. For example, the attributes are attributes of the feature amounts matching the captured image in Step S12.

Subsequently, the position detection unit 172 outputs the position of the target detected in Step S13 and the target detection unit 171 outputs the attributes of the target determined in Step S14 and proceeds to Step S2 (FIG. 4) (Step S15).

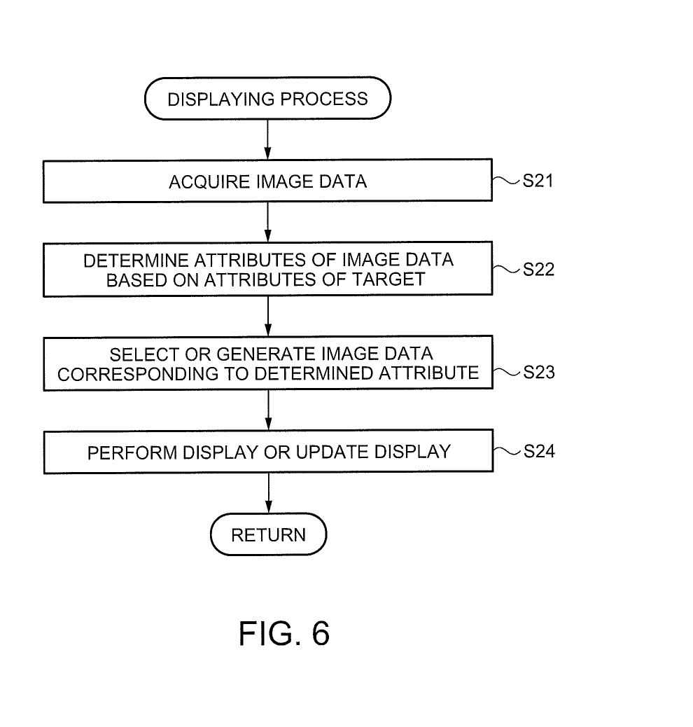

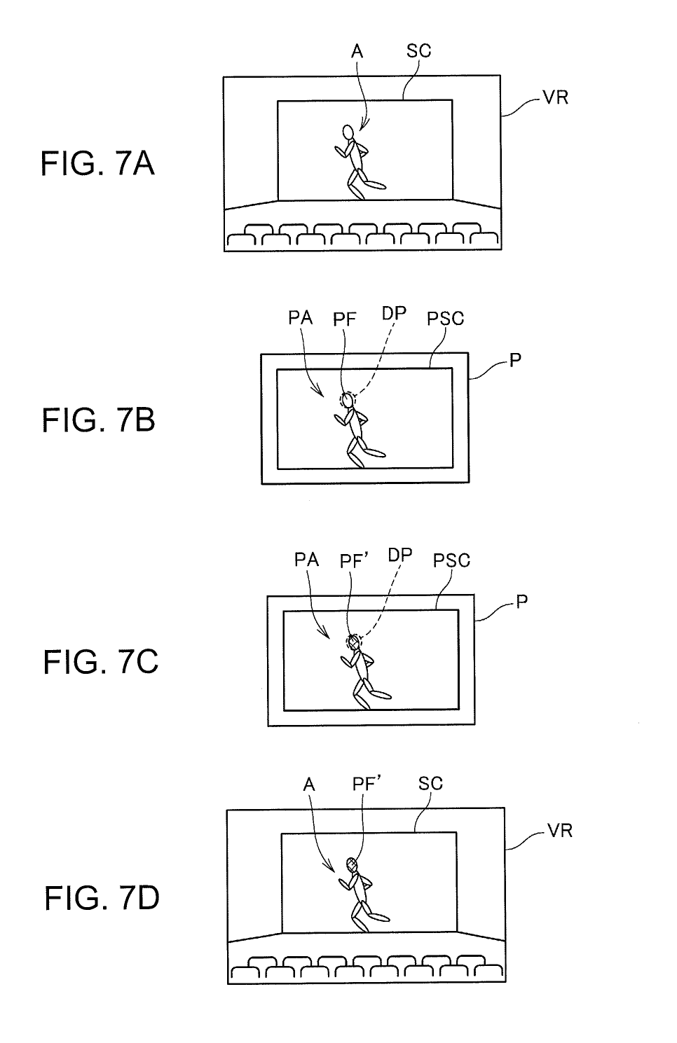

FIG. 6 is a flowchart specifically illustrating the displaying process. Further, FIGS. 7A to 7D are views illustrating typical application examples of the head mounted display device 100. FIG. 7A illustrates an example of the field of vision VR of the user, FIG. 7B illustrates an example of a captured image P, FIG. 7C illustrates an example in which an image is overlapped with the field of vision VR based on the captured image P, and FIG. 7D illustrates an example of the field of vision VR of the user in the case where the image is overlapped with the field of vision VR.

In the example of FIG. 7A, a user sees a video such as a movie or the like reflected on a screen SC and an image of the screen SC is captured in the field of vision VR. The image projected on the screen SC includes a person image A. In the person image A, the person is, for example, a character in a movie.

FIG. 7B illustrates a captured image captured by the camera 61 in this state. A captured image P includes an image PSC of the screen SC and an image PA of the person image A.

The target detection unit 171 detects a face portion PF of the image PA of the person image A from the captured image P based on the detected feature data 124 including the feature amount for detecting a face of a person. The target detection unit 171 detects the face portion PF and outputs the attributes of the face portion PF. Further, the position detection unit 172 detects the position in a detected range DP including the face portion PF.

The image display control unit 176 acquires the replacement image data 125 stored in the memory unit 120 (Step S21). Here, the image display control unit 176 determines the attributes of the image data corresponding to the attributes output by the target detection unit 171 (Step S22). In the present embodiment, since the attributes of the feature amount of the detected feature data 124 and the attributes of the image data included in the replacement image data 125 are in one-to-one correspondence, the image display control unit 176 sets the attributes detected by the target detection unit 171 as attributes of the image data as they are.

The image display control unit 176 selects the image data corresponding to the determined attributes from the replacement image data 125 (Step S23). Here, the image display control unit 176 may generate image data for display based on the image data selected from the replacement image data 125. For example, the image display control unit 176 performs a process of adjusting hue (color tone) or brightness; a coloring process or a monochromatic process; a process of converting resolution; or a process of adjusting the size with respect to the image data selected from the replacement image data 125 and may generate image data which is the target to be displayed. In this case, the image can be adjusted according to the face portion PF detected by the target detection unit 171. Further, the image display control unit 176 extracts one piece of or a plurality of pieces of image data from the replacement image data 125 and may generate image data for display from the plurality of pieces of image data. For example, the image display control unit 176 may generate image data of a face seen from the oblique direction based on the image data of a face seen from the front side and the image data of a side face.

Here, the image display control unit 176 may select or generate image data used for display and then perform a process of adjusting an image. As a specific example of the image adjusting process, a process of adjusting the display color or brightness of the edge of an image in a case where the image based on the image data for display overlaps the target can be exemplified. In this case, the target detection unit 171 may adjust the color or brightness of the edge of the image according to the color or brightness of the target image detected from the captured image of the camera 61. Specifically, the color or brightness of pixels in the edge of the image may be set to an intermediate value between the color and the brightness of the image of the target detected by the target detection unit 171. In this case, there is an advantage that the boundary between the image displayed by the image display control unit 176 and the target in the outside scenery seen by the user becomes less noticeable.

In addition, in a case where an image of the target moves in a displayable region of the image display unit 20, the image display control unit 176 may move the display position according to the movement. The motion of the target is generated in a case where the head of the user is moved as well as a case where the target itself is moved. Accordingly, the image display control unit 176 detects a change of a position of the target with time which is detected by the position detection unit 172, predicts the change of the position of the target, and then moves the display position of the image according to the change of the predicted position. Moreover, a filter coefficient that prevents an image blur displayed by the image display control unit 176 may be stored in the memory unit 120. The filter coefficient is also referred to as a stabilize coefficient and prevents or suppresses a blur of a moving image or movement (warpage). The memory unit 120 stores a plurality of filter coefficients and the image display control unit 176 may select and use the filter coefficient.

Subsequently, the image display control unit 176 outputs the image data to the display control unit 190 based on the position detected by the position detection unit 172, performs display using the image display unit 20, updates the display during the process (Step S24), and proceeds to Step S3 (FIG. 4).

In the example of FIG. 7C, an image PF′ of a face is displayed such that the image overlaps the face portion PF which is the target detected by the target detection unit 171. The position in which the image display unit 20 displays the image PF′ is a position in which the user visually recognizes the face portion PF.

Accordingly, in the field of vision VR of the user, as illustrated in FIG. 7D, the image PF′ is seen by the user such that the image PF′ overlaps the face portion of the person image A. Here, the image display control unit 176 may decrease the transparency of the image PF′ so that the image PF′ is not seen through. In this case, the face of the person image A captured in the screen SC through the image PF′ is not seen and the face of the person image A appears to be replaced by the image PF′. The adjustment of the transparency can be easily performed by increasing the brightness of the image PF′.

Not limited to the examples of FIGS. 7C and 7D, the image display control unit 176 may display an image by overlapping the image with a plurality of targets. In addition, in a case where the target detection unit 171 detects a plurality of targets, the user may select one or a plurality of targets through the operation of the control device 10 and the image may be displayed by being overlapped with the selected target by the image display control unit 176. Further, the image display control unit 176 may select one or a plurality of targets based on the attributes of the target in a case where the target detection unit 171 detects a plurality of targets. For example, in a case where a plurality of faces directed to different directions are detected, only a face directed to the front side may be selected. In addition, for example, a target may be selected based on the color of clothes in a case where a plurality of people are detected and a vehicle having a specific color may be selected in a case where a plurality of vehicles are detected.

Further, in the process of FIG. 4, in a case where the target detecting process of Step S1 is repeatedly performed, the target detection unit 171 may perform a process of tracking a temporarily detected image. That is, the target detection unit 171 detects an image as a target and compares a captured image to be detected and a captured image detected in the past in a case of performing the target detecting process again. The target detection unit 171 detects the movement of an image in a case where the captured image to be detected and the captured image detected in the past are similar to each other and tracks the movement of an image of a detected target. In this manner, the target detection unit 171 can detect the target from the captured image to be detected without performing a matching process. Such a technique is effective since a processing load can be reduced in a case where the camera 61 captures a moving image at a predetermined frame rate (for example, 30 frame/sec) and the target detection unit 171 detects a target for each frame.

As described above, the head mounted display device 100 according to the embodiment to which the invention is applied is a head mounted display device 100 used by being mounted on the body of the user and includes the image display unit 20 through which outside scenery is transmitted and that displays an image such that the image is visually recognizable together with the outside scenery. Further, the head mounted display unit 100 further includes the target detection unit 171 that detects a target of the user in a visual line direction and the data acquisition unit DA that acquires data of the image displayed by the image display unit 20. The head mounted display device 100 allows the image to be displayed based on the data acquired by the data acquisition unit DA such that the image overlaps at least a part of the target detected by the target detection unit 171 using the image display control unit 176. In this manner, since the image can be displayed so as to overlap the target seen as the outside scenery, it is possible to change the appearance of the target present outside of the head mounted display device 100 using an image being displayed by the head mounted display device 100. Accordingly, it is possible to provide a new utilization method of displaying an image using the head mounted display device 100 by effectively combining the outside scenery present outside of the head mount display device 100 and the display contents.

For example, the head mounted display device 100 displays an image in a position which is seen by being overlapped with the target by the user through the image display unit 20. The position in which the image is displayed is determined by the image display control unit 176 according to the position in which the user visually recognizes the target. For example, the image may be displayed in the whole displayable region of the image display unit 20 and the position in which the image is displayed may be determined or adjusted according to the position of the target detected by the position detection unit 172.

In addition, the target detection unit 171 detects a target having a predetermined attribute and the image display control unit 176 allows the image display unit 20 to display an image having an attribute corresponding to the attribute of the target detected by the target detection unit 171. Accordingly, the image corresponding to the attribute of the target seen as the outside scenery is displayed so as to be seen by being overlapped with the target. For this reason, it is possible to change the appearance of the target using an image displayed by the head mounted display device 100 corresponding to the attribute of the target. The attribute of the target can be variously determined in regard to a person or an object serving as a target as described above and is not limited to a person or a person's face. Further, the attribute of the image to be displayed in correspondence with the attribute of the target is optional and the attribute of the target and the attribute of the image may not be in one-to-one correspondence.

Here, the image display control unit 176 may allow the user to visually recognize a stereoscopic (3D) image by allowing an image having a parallax to be displayed by the right optical image display unit 26 and the left optical image display unit 28. In this case, whether to display the image as a stereoscopic image or a planar image may be set or changed by the image display control unit 176 as one of the display modes.

In addition, the head mounted display device 100 includes the memory unit 120 that stores the detected feature data 124 correlating the features of the target to be detected by the target detection unit 171 and the attributes of the target. The target detection unit 171 detects the target corresponding to the detected feature data 124 and can rapidly determine the attributes of the detected target.

In addition, since the image display control unit 176 generates an image having attributes corresponding to the attributes of the target detected by the target detection unit 171 or acquires the image corresponding to the attributes from the replacement image data 125 stored in the memory unit 120, the image corresponding to the attributes of the target can be suitably displayed.

In a case where a stereoscopic image is visually recognized by the user, the image display control unit 176 may detect the distance to the target detected by the target detection unit 171. The distance is a distance from the head mounted display device 100 (image display unit 20) to the target and can be acquired based on the size of the image of the target detected by the target detection unit 171 in the captured image of the camera 61. Further, the head mounted display device 100 may include a distance meter that detects the distance to the target using laser light or ultrasonic waves. The distance meter includes a light source of laser light and a light receiving unit that receives reflected light of laser light emitted from the light source and detects the distance to the target based on a state in which the reflected light of laser light is received. Moreover, the distance meter may be, for example, an ultrasonic wave type distance meter. That is, a distance meter that includes a sound source emitting ultrasonic waves and a detection unit detecting ultrasonic waves reflected by the target and detecting the distance to the target based on the reflected ultrasonic waves may be used. Further, the distance meter can have a configuration in which a distance meter using laser light and a distance meter using ultrasonic waves are combined with each other. It is preferable that such a distance meter is provided in the right holding unit 21 of the image display unit 20 or the right display driving unit 22 and the distance meter may be disposed, for example, in a surface linearly arranged with the light adjusting plate 20A in a state of being directed to the front side. It is preferable that the direction in which the distance meter measures the distance is a visual line direction of the user similar to the imaging direction of the camera 61.

In a case where the distance to the target is acquired using various methods described above, the image display control unit 176 may determine the parallax of the image to be seen by the user corresponding to the acquired distance. For example, the image display control unit 176 generates stereoscopic image data for display from the data acquired by the data acquisition unit DA such that the parallax becomes small as the distance to the target becomes closer and the parallax becomes larger as the distance to the target becomes farther. In addition, the image display control unit 176 may generate stereoscopic image data corresponding to the attributes of the target. For example, the parallax may be changed in correspondence with the fact that the target detected by the target detection unit 171 is a face of a specific person or a character modeled on the shape of a person, a normal person's face or an image modeled on the shape of a person's face and the face is directed to the front side or not when the image is a person's face. In this case, when the target is a face directed to the user from the front side of the user, the parallax thereof is decreased and the image overlapping the face is set to be seen close to the user. In addition, the image display control unit 176 may increase or decrease the parallax thereof corresponding to the size of the image of the target in the captured image of the camera 61.

In addition, the head mounted display device 100 includes the camera 61 that images the visual line direction of the user and the target detection unit 171 detects the target visually recognized by the user through the image display unit 20 by detecting an image corresponding to the features of the target from the captured image of the camera 61. Accordingly, the target in the visual line direction of the user can be easily detected based on the captured image.

In addition, the head mounted display device 100 includes the position detection unit 172 that detects the position of the target with respect to the display region of the image display unit 20. The image display control unit 176 determines the display position of the image based on the position of the target detected by the position detection unit 172 and allows the image display unit 20 to display an image. In this manner, the image can be displayed by matching the position of the target.

In addition, since the position detection unit 172 detects the position in which the user visually recognizes the target through the display region of the image display unit 20, the image can be displayed by matching the position in which the user can see the target.

Further, the invention is not limited to the configurations of the above-described embodiment and various modifications are possibly performed in the range without departing from the scope of the invention.

For example, in the above-described embodiments, the example in which the target detection unit 171 detects a person's face or an image modeled on the shape of a person's face has been described, but the invention is not limited thereto and the shape or the kind of the target is optional. In addition, in the above-described embodiment, the attributes of an image of the target detected by the target detection unit 171 have been described as the directions of a face, but the invention is not limited thereto. The attributes of the image of the target have an effect of preventing the sense of discomfort when a replaced image is displayed as illustrated in FIG. 7D by correlating the image to be detected by the target detection unit 171 and the image to be displayed by the image display control unit 176. Within the range in which the above-described effect can be obtained, the brightness, the hue, or the size of an image and the kind of the image can be optionally included in the attributes.

In addition, the description is made that the position detection unit 172 detects the position of the target based on the captured image of the camera 61, but the invention is not limited thereto. For example, the position detection unit 172 may detect the position of the target based on a signal transmitted from another external device. Specifically, in a case where light beams (infrared rays or the like) in the outside of the visible region are sent from a device mounted on the target, the light beams are received and the position of the target may be detected. In place of the light beams, a wireless signal is sent from an external device, the head mounted supply device 100 receives the wireless signal, and the position detection unit 172 may detect the position. A light beacon or a radio beacon in the related art can be employed as a specific example thereof. In this case, the distance between the target and the head mounted display device 100 may be detected. Further, the position of the target may be acquired based on the signal transmitted from the external device detecting the position of the target. Further, the position detection unit 172 may detect the position of the target based on a plurality of pieces of information such as a captured image of the camera 61, the light beams, or a signal.

In addition, the target detection unit 171 may detect the target of the user in the visual line direction and is not limited to a target detection unit detecting a target from the captured image of the camera 61. For example, the target detection unit 171 may detect the position of the target based on a signal transmitted from another external device. Specifically, in a case where light beams (infrared rays or the like) in the outside of the visible region are sent from a device mounted on the target, the light beams are received and the position of the target may be detected. In place of the light beams, a wireless signal is sent from an external device, the head mounted supply device 100 receives the wireless signal, and the target detection unit 171 may detect the target. A light beacon or a radio beacon in the related art can be employed as a specific example thereof. In this case, the position detection unit 172 receives the light or the wireless signal as described above and may detect the position of the target.

Further, the target detection unit 171 and the position detection unit 172 may include a visual line detection unit that detects a visual line of the user. For example, the visual line direction may be specified based on the captured image by providing a camera directed to the side of the eyes of the user in the image display unit 20 and detecting the color of the user and the direction or the motion of the pupils of the user with the camera. In this case, the target detection unit 171 may detect the target by extracting the image of the target positioning in the visual line direction of the user detected by the visual line detection unit from the captured image of the camera 61. The position detection unit 172 sets the intersection point between the visual line direction detected by the visual line detection unit and the display region of the image display unit 20 as a reference (for example, the center) of the position in which the user visually recognizes the target. The position detection unit 172 can specify the position in which the user visually recognizes the target or the range visually recognized by the user as the position in the display region of the image display unit 20.

In addition, the configurations of the target detection unit 171 and the position detection unit 172 are not limited to configurations realized as a part of the functions included in the control unit 140 as described above and may be one of a functional unit separately provided from the control unit 140 and a unit separately provided from the image display unit 20.

In addition, in place of the image display unit 20, an image display unit having another system such as an image display unit to be mounted on the head of the user, for example, a cap or the like may be employed as an image display unit and may include a display unit that displays an image corresponding to the left eye of the user and a display unit that displays an image corresponding to the right eye of the user. In addition, the display device according to the invention may be configured as a head mounted display to be installed in a vehicle such as an automobile or an airplane. In addition, for example, the display device may be configured as a head mounted display built in a body-protecting tool such as a helmet or a head-up display (HUD) used for front glass of an automobile. A display for forming an image on retinas in the eyeballs of the user such as a so-called contact lens type display used by being mounted on both eyeballs (for example, on the cornea) of the user or an implantable display used by being embedded in the eyes may be used as the image display unit 20.

Further, the display device of the present application may be a device to be mounted on a body and such a device can be applied regardless of whether support using another technique is necessary or not. For example, a binocular type hand held display used by being held with both hands of the user may be employed as the image display unit 20 of the present application. Such a display is included in the display device according to the invention because the device is put on the head or the face of the user when the user sees a displayed image of the display even though the user needs to hold the device by hand for holding the state of being mounted on the head of the user. In addition, a device which is put on the head or the face of the user when the user sees a displayed image of the device is included in the display device according to the invention even through the device is a display device to be fixed on a floor surface or a wall surface using support legs or the like.

In addition, only a display unit having a configuration of the image display unit 20 or a configuration according to the image display in the image display unit 20 is mounted on the body of the user and a control system including the control device 10 other than the display unit or the control device 10 and the display unit 140 may be configured as a physically separate body. For example, a device having another control system is connected to a display unit formed of the image display unit 20 or a part of the image display unit 20 in a wireless manner and may be set as a display unit similar to the head mounted display device 100. Examples of the device having such a control system include a smartphone, a mobile phone, a tablet computer, a personal computer having another shape, and an existing electronic device. It is needless to say that the present application can be applied to such a display device.

In addition, in the above-described embodiment, the example of the configuration in which the image display unit 20 and the control device 10 are separated from each other and connected to each other through the connecting unit 40 has been described, but a configuration in which the control device 10 and the image display unit 20 are integrated with each other and mounted on the head of the user can be employed.

In addition, the control device 10 and the image display unit 20 are connected to each other through a longer cable or a wireless communication line and a mobile electronic device including a laptop computer, a tablet computer, a desktop computer, a game machine, a mobile phone, a smartphone, or a portable media player; or a dedicated device may be used as the control device 10.

In addition, for example, as a configuration of generating image light in the image display unit 20, a configuration that includes an organic electroluminescence (EL) display and an organic EL control unit may be employed and liquid crystal on silicon (LCoS; registered trademark), a digital micromirror device or the like can be used. Further, for example, the invention can be applied to a laser retina projection type head mounted display. That is, a configuration of allowing the user to visually recognize an image in a manner in which the image generation unit includes a laser light source and an optical system that guides the laser light source to the eyes of the user, the laser light is incident to the eyes of the user to scan the retinas, and an image is formed on the retinas may be employed. In a case where a laser retina projection type head mounted display is employed, the expression “a region in which image light in an image light generation unit can be emitted” can be defined as an image region to be visually recognized by the eyes of the user.

As an optical system that guides image light to the eyes of the user, a configuration that includes an optical member through which external light incident toward a device from the outside is transmitted and allows the image light and the external light to be incident to the eyes of the user can be employed. Further, an optical member that is positioned on the front side of the eyes of the user and overlapped with a part or the entire visual field of the user may be used. In addition, a scanning type optical system of scanning laser light or the like to be used as image light may be employed. Further, the optical system is not limited to an optical system of guiding image light in the inside of the optical member, and an optical system that has only a function of guiding image light toward the eyes of the user by refracting and/or reflecting the image light may be employed.

Moreover, the invention may be applied to a display device to which a scanning optical system using an MEMS mirror is employed and which uses an MEMS display technique. That is, as image display elements, the display device may include a signal light forming unit, a scanning optical system having an MEMS mirror that scans light emitted by the signal light forming unit, and an optical member on which a virtual image is formed due to light scanned by the scanning optical system. In this configuration, the light emitted by the signal light forming unit is reflected on the MEMS mirror to be incident on the optical member, guided through the optical member, and reaches a surface on which a virtual image is formed. A virtual image is formed on the surface on which a virtual image is formed by scanning the light using the MEMS mirror and an image is visually recognized by the user capturing the virtual image with the eyes. An optical component in this case may be a component that guides light after performing reflection plural times such as the right light guide plate 261 and the left light guide plate 262 according to the above described embodiment or a half mirror surface may be used.

In addition, the display device according to the invention is not limited to a head mounted display device and various display devices such as a flat panel display and a projector can by employed. The display device according to the invention may be a device that allows a user to visually recognize an image using external light and image light and a device having a configuration in which an image is visually recognized by the user due to an optical member through which the external light is transmitted using the image light can be exemplified. Specifically, the invention can be applied to a display device that projects image light on a transmissive flat surface or curved surface (glass or transparent plastic) which is fixedly or movably arranged on a position separated from the user in addition to the configuration including an optical member through which the external light is transmitted in the above-described head mounted display. As an example, a configuration of a display device that allows a user riding on a vehicle or a user outside the vehicle to visually recognize the scenery, other than the vehicle, together with an image due to image light by projecting the image light on window glass of the vehicle can be exemplified. Further, a configuration of a display device that allows a user present in the vicinity of a display surface to visually recognize the scenery through the display surface together with an image due to image light by projecting the image light on a transparent, semitransparent, or colored transparent display surface fixedly arranged such as window glass of a building can be exemplified.

Further, a configuration in which at least a part of each functional block illustrated in FIG. 2 may be realized in hardware or realized in cooperation of hardware and software may be employed. In addition, the configuration is not limited to a configuration in which independent hardware resources are arranged as illustrated in FIG. 2. In addition, a program executed by the control unit 140 may be stored in the memory unit 120 or a memory unit in the control device 10 or may be executed by acquiring a program stored in an external device through the communication unit 117 or the interface 180. In addition, only the operation unit 135 may be formed as a single user interface (UI) in a configuration formed in the control device 10 or the power supply 130 in the present embodiment may be singly formed and exchangeable. In addition, the configuration formed in the control device 10 may be repeatedly formed in the image display unit 20. For example, the control unit 140 illustrated in FIG. 2 may be formed in both of the control device 10 and the image display unit 20 or functions of the control unit 140 formed in the control device 10 and the CPU formed in the image display unit 20 may be separately divided.

The entire disclosure of Japanese Patent Application No. 2014-156647, filed Jul. 31, 2014 is expressly incorporated by reference herein.

What is claimed is:

1. A display device which is used by being mounted on a body of a user, the display device comprising:
a display unit through which outside scenery is transmitted and that displays an image such that the image is visually recognizable together with the outside scenery;
a target detection unit that detects a target of the user in a visual line direction;
a data acquisition unit that acquires data of the image displayed by the display unit; and
an image display control unit that allows the image to be displayed based on the data acquired by the data acquisition unit such that the image overlaps at least apart of the target detected by the target detection unit.

2. The display device according to claim 1,
wherein the target detection unit detects the target having a predetermined attribute, and
the image display control unit allows the display unit to display the image having an attribute corresponding to the attribute of the target detected by the target detection unit.

3. The display device according to claim 2, further comprising a memory unit that stores features of the target detected by the target detection unit and feature data in correspondence with the attribute of the target,
wherein the target detection unit detects the target corresponding to the feature data and determines the attribute of the detected target.

4. The display device according to claim 2, wherein the image display control unit generates the image having an attribute corresponding to the attribute of the target detected by the target detection unit or acquires the image corresponding to the attribute of the target from the image included in the data acquired by the data acquisition unit.

5. The display device according to claim 1, further comprising an imaging unit that images the visual line direction of the user,
wherein the target detection unit detects the target which is visually recognized by the user through the display unit by detecting an image corresponding to a feature of the target from the captured image of the imaging unit.

6. The display device according to claim 1, further comprising a position detection unit that detects a position of the target with respect to a display region of the display unit,
wherein the image display control unit determines a display position of an image based on the position of the target detected by the position detection unit and allows the display unit to display the image.

7. The display device according to claim 6, wherein the position detection unit detects a position in which the user visually recognizes the target through the display region of the display unit.

8. A method of controlling a display device which includes a display unit through which outside scenery is transmitted and that displays an image such that the image is visually recognizable together with the outside scenery and which is used by being mounted on a body of a user, the method comprising:
detecting a target of the user in a visual line direction;
acquiring data of the image displayed by the display unit; and
allowing the image to be displayed based on the acquired data such that the image overlaps at least a part of the target.

9. A program which can be executed by a computer controlling a display device that includes a display unit through which outside scenery is transmitted and that displays an image such that the image is visually recognizable together with the outside scenery and is used by being mounted on a body of a user, the program causing the computer to function as:
a target detection unit that detects a target of the user in a visual line direction;
a data acquisition unit that acquires data of the image displayed by the display unit; and
an image display control unit that allows the image to be displayed based on the data acquired by the data acquisition unit such that the image overlaps at least a part of the target detected by the target detection unit.
